(19) United States
(12) Patent Application Publication
(10) Pub. No.: US 2024/0242321 A1
(43) Pub. Date: Jul. 18, 2024

(54) IMAGE PROCESSING DEVICE AND IMAGE PROCESSING METHOD

(71) Applicant: SK hynix Inc., Icheon-si Gyeonggi-do (KR)

(72) Inventors: Jun Hyeok CHOI, Icheon-si Gyeonggi-do (KR); Dong Ik KIM, Icheon-si Gyeonggi-do (KR); Cheol Jon JANG, Icheon-si Gyeonggi-do (KR)

(73) Assignee: SK hynix Inc., Icheon-si Gyeonggi-do (KR)

(21) Appl. No.: 18/354,228

(22) Filed: Jul. 18, 2023

(30) Foreign Application Priority Data
Jan. 16, 2023 (KR) 10-2023-0006127

(51) Int. Cl. G06T 7/00; G06T 5/00; G06T 7/62; G06T 7/90; G06V 10/56

(52) U.S. Cl. CPC G06T 7/0002; G06T 5/005; G06T 7/62; G06T 7/90; G06V 10/56; G06T 2207/10024

(57) ABSTRACT

Provided herein may be an image processing device and an image processing method. The image processing device may include a determination area manager configured to generate a determination area corresponding to a candidate defective pixel based on externally received pixel values and configured to determine whether the determination area is saturated based on pixel values of white pixels included in the determination area, and a defective pixel manager configured to calculate a reference value based on first pixel values of reference pixels that are set based on whether the white pixels are saturated and to determine whether a candidate defective pixel has a defect, based on both the reference value and second pixel values of determination pixels having a color identical to that of the candidate defective pixel, among pixels included in the determination area.

### CROSS-REFERENCE TO RELATED APPLICATION

The present application claims priority under 35 U.S.C. § 119(a) to Korean patent application number 10-2023-0006127 filed on Jan. 16, 2023, in the Korean Intellectual Property Office, the entire disclosure of which is incorporated by reference herein.

### BACKGROUND

### 1. Technical Field

Various embodiments of the present disclosure generally relate to an image processing device, and more particularly to an image processing device and an image processing method.

### 2. Related Art

Generally, image sensors may be classified into a charge coupled device (CCD) image sensor and a complementary metal oxide semiconductor (CMOS) image sensor. Recently, the CMOS image sensor, which has a low manufacturing cost, has low power consumption, and facilitates integration with a peripheral circuit, has attracted attention.

An image sensor included in a smartphone, a tablet PC, or a digital camera may acquire image information of an external object by converting light reflected from the external object into an electrical signal. The image sensor may generate image data including phase information.

The image processing device may correct pixel values received from the image sensor, thus improving the quality of an image. A white pixel or a pixel having no color filter may be included in the color filters of the image sensor. Because the white pixel may be highly sensitive to light compared to other color pixels, it may be rapidly saturated.

A method of detecting and correcting a defective pixel for a conventional RGB color filter may have low detection accuracy or falsely correct pixel values when being applied to pixel values including white pixels. There is required a method of detecting and correcting defective pixels from pixel values generated by the image sensor including white pixels.

### SUMMARY

An embodiment of the present disclosure may provide for an image processing device. The image processing device may include a determination area manager configured to generate a determination area corresponding to a candidate defective pixel based on externally received pixel values and configured to determine whether the determination area is saturated based on pixel values of white pixels included in the determination area, and a defective pixel manager configured to calculate a reference value based on first pixel values of reference pixels that are set based on whether the white pixels are saturated and to determine whether a candidate defective pixel has a defect, based on both the reference value and second pixel values of determination pixels having a color identical to that of the candidate defective pixel, among pixels included in the determination area.

An embodiment of the present disclosure may provide for an image processing method. The image processing method may include generating a determination area corresponding to a candidate defective pixel based on externally received pixel values, determining whether the determination area is saturated based on pixel values of white pixels included in the determination area, calculating a reference value based on first pixel values of reference pixels that are set based on whether the white pixels are saturated, and determining whether the candidate defective pixel has a defect based on both the reference value and second pixel values of determination pixels having a color identical to that of the candidate defective pixel, among pixels included in the determination area.

An embodiment of the present disclosure may provide for an image processing system. The image processing system may include an image sensor including white pixels and non-white color pixels, and an image processing device configured to detect defective pixels included in the image sensor based on pixel values received from the image sensor and configured to correct pixel values of the defective pixels. The image processing device may include a determination area manager configured to generate a determination area corresponding to a candidate defective pixel based on the pixel values and configured to determine whether the determination area is saturated based on pixel values of white pixels included in the determination area, a defective pixel manager configured to set white pixels included in the determination area or pixels of another color, among the non-white color pixels, next largest to a number of white pixels included in the determination area, as reference pixels based on whether the white pixels are saturated, to calculate a reference value based on first pixel values of the reference pixels, and to determine the candidate defective pixel to be a defective pixel or a normal pixel based on both the reference value and second pixel values of determination pixels having a color identical to that of the candidate defective pixel, among the pixels included in the determination area, and a pixel value corrector, in response to a case in which the candidate defective pixel is determined to be a defective pixel, configured to calculate slope values for preset directions based on the first pixel values, to calculate temporary correction values corresponding to the preset directions based on the second pixel values, to calculate a correction value by obtaining a weighted sum of reciprocals of the slope values and the temporary correction values, and to output the correction value as a pixel value of the defective pixel.

### BRIEF DESCRIPTION OF THE DRAWINGS

FIG. 1 is a diagram illustrating an image processing device according to an embodiment of the present disclosure.

FIG. 2 is a diagram illustrating a method of detecting and correcting a defective pixel according to an embodiment of the present disclosure.

FIG. 3 is a diagram illustrating directions and slope values for correcting pixel values according to an embodiment of the present disclosure.

FIG. 4 is a flowchart illustrating an image processing method according to an embodiment of the present disclosure.

FIG. 5 is a flowchart illustrating a method of correcting a defective pixel according to an embodiment of the present disclosure.

FIG. 6 is a block diagram illustrating an electronic device including an image processing device according to an embodiment of the present disclosure.

### DETAILED DESCRIPTION

Specific structural or functional descriptions in the embodiments of the present disclosure introduced in this specification or application are provided as examples to describe embodiments according to the concept of the present disclosure. The embodiments according to the concept of the present disclosure may be practiced in various forms and should not be construed as being limited to the embodiments described in the specification or application.

Various embodiments of the present disclosure will now be described in detail with reference to the accompanying drawings so that those skilled in the art can easily practice the technical spirit of the present disclosure.

Various embodiments of the present disclosure are directed to an image processing method and an image processing method, which detect a defective pixel based on pixel values received from an image sensor including existing RGB pixels and white pixels and correct the pixel value of the defective pixel.

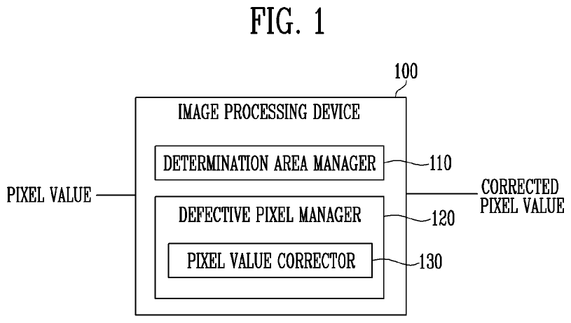

FIG. 1 is a diagram illustrating an image processing device according to an embodiment of the present disclosure.

An image sensor may include a pixel array and a color filter array. The pixel array may include pixels, and the color filter array may include white, green, blue, and red color filters. The pixels may correspond to respective color filters. Hereinafter, a pixel corresponding to a white color filter may be referred to as a white pixel, a pixel corresponding to a green color filter may be referred to as a green pixel, and pixels corresponding to blue and red color filters may be referred to as a blue pixel and a red pixel, respectively. The number of white pixels may be greater than the numbers of green, blue, and red pixels based on the arrangement of the color filter array. Because the white pixels may absorb light corresponding to all wavelengths, they may be more rapidly saturated than other pixels.

Referring to FIG. 1, an image processing device 100 may receive pixel signals respectively corresponding to pixels included in the image sensor. Hereinafter, the pixel signals received from the image sensor may be referred to as pixel values. The pixel values may include information regarding color filters respectively corresponding to the pixels. The image processing device 100 may receive pixel values from the image sensor and may output the corrected pixel values.

The image processing device 100 may include a determination area manager 110 and a defective pixel manager 120. In an embodiment of the present disclosure, the image processing device 100 may select a candidate defective pixel from among the pixels included in the image sensor. The image processing device 100 may determine whether the candidate defective pixel has a defect based on the pixel values received from the image sensor and may detect a defective pixel from the pixels included in the image sensor. The image processing device 100 may correct the pixel value of the defective pixel by using the pixel values of neighboring pixels.

The determination area manager 110 may generate a determination area corresponding to the candidate defective pixel. The determination area manager 110 may set pixels having the same color as the candidate defective pixel, among the pixels included in the determination area, as determination pixels. The determination area manager 110 may determine the size of the determination area so that the determination area includes a preset number of determination pixels. In an embodiment of the present disclosure, the size of the determination area may vary based on the pattern of the color filter array and the color of the candidate defective pixel.

The determination area manager 110 may determine whether the generated determination area is saturated. The determination area manager 110 may determine whether white pixels are saturated by comparing the pixel values of the white pixels included in the determination area with a preset saturation reference value. The determination area manager 110 may determine whether the determination area is saturated based on the number of saturated white pixels, among white pixels included in the saturation area. The defective pixel manager 120 may set a reference pixel based on whether the determination area is saturated. When the determination area is not saturated, white pixels included in the determination area may be set as reference pixels. When the determination area is saturated, green pixels included in the determination area may be set as the reference pixels. In an embodiment, the color of reference pixels to be set based on whether the determination area is saturated may be a color other than white and green. The defective pixel manager 120 may calculate a reference value that is used to determine whether the candidate defective pixel has a defect by using the pixel values of the reference pixels included in the determination area.

The defective pixel manager 120 may include a pixel value corrector 130 that determines the candidate defective pixel to be a defective pixel and corrects the pixel value of the defective pixel. Although the pixel value corrector 130 is illustrated as being included in the defective pixel manager 120 in FIG. 1, the pixel value corrector 130 may be included only in the image processing device 100 without being included in the defective pixel manager 120 in other embodiments.

The pixel value corrector 130 may calculate slope values and temporary correction values by using the pixel values of neighboring pixels. The pixel value corrector 130 may correct the pixel value of the defective pixel by using the slope values and the temporary correction values and may output the corrected pixel value.

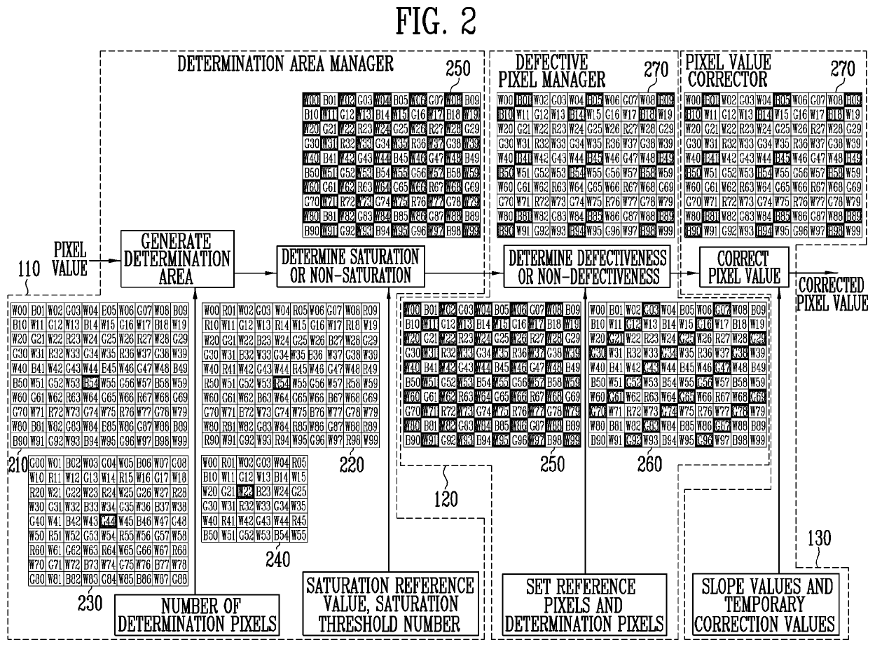

FIG. 2 is a diagram illustrating a method of detecting and correcting a defective pixel according to an embodiment of the present disclosure.

Referring to FIG. 2, an image processing device may detect a defective pixel based on externally received pixel values, correct the pixel value of the detected defective pixel, and output the corrected pixel value.

The determination area manager 110 may generate a determination area corresponding to a candidate defective pixel based on the externally received pixel values. When the candidate defective pixel is selected, the determination area manager 110 may generate the determination area including the candidate defective pixel. FIG. 2 may illustrate an example of determination areas 210, 220, 230, and 240 corresponding to a case in which the colors of candidate defective pixels are blue, red, green, and white.

The determination area manager 110 may determine the sizes of the determination areas based on the colors of respective candidate defective pixels. The determination area manager 110 may control the size of each determination area so that the corresponding determination area includes a preset number of determination pixels. The determination pixels may refer to pixels having the same color as each candidate defective pixel, among pixels included in the corresponding determination area. The number of determination pixels to be included in the corresponding determination area may vary. The size of each determination area may vary based on the color of each candidate defective pixel and the pattern of a color filter array.

The determination area manager 110 may determine the size of each determination area so that the number of determination pixels is equal to or greater than a preset threshold value. In an embodiment of the present disclosure, the determination area manager 110 may generate the determination area so that the corresponding determination area includes at least 18 determination pixels.

Reference numeral 210 of FIG. 2 shows a determination area corresponding to the case in which a candidate defective pixel is a blue pixel B54. When the candidate defective pixel is a blue pixel, the determination pixel may be a blue pixel. The size of the determination area including at least 18 blue pixels may be 10×10.

Reference numeral 220 of FIG. 2 shows a 10×10 determination area including 18 or more red pixels in response to the case in which the candidate defective pixel is a red pixel R54.

Reference numeral 230 of FIG. 2 shows a 9×9 determination area including 18 or more green pixels, which are determination pixels, in response to the case in which the candidate defective pixel is a green pixel G44. The number of green pixels included in the 9×9 determination area 230 may be 21. Because the number of green pixels is 18 or more, reference numeral 230 may satisfy a requirement for the number of determination pixels.

Reference numeral 240 of FIG. 2 shows a determination area corresponding to the case in which a candidate defective pixel is a white pixel W22. The size of a determination area including 18 or more white pixels may be 6×6.

In an embodiment of the present disclosure, the number of white pixels or the number of green pixels may be greater than that of blue pixels or red pixels based on the pattern of the color filter array. The size of the determination area that is generated when the candidate defective pixel is a blue pixel or a red pixel may be greater than that of the determination area that is generated when the candidate defective pixel is a green pixel or a white pixel. As the number of determination pixels included in the determination area increases, the accuracy of detecting and correcting a defective pixel may be improved. In order to guarantee uniform detection reliability and accuracy, the determination area manager may determine the number of determination pixels to be included in each determination area.

For convenience of description, it may be assumed that the candidate defective pixel is the blue pixel B54 in the following description. Reference numeral 210 of FIG. 2 may be described as an example of the determination area.

Based on the pixel values of white pixels included in the determination area, the determination area manager 110 may determine whether the determination area is saturated. Reference numeral 250 of FIG. 2 represents white pixels included in the determination area by shaded portions. Whether the determination area is saturated may be determined based on the number of saturated white pixels, among the white pixels included in the determination area.

The determination area manager 110 may count the number of saturated pixels, the pixel values of which are greater than a saturation reference value, among the white pixels. Based on the number of saturated pixels and a saturation threshold number, the determination area manager 110 may determine whether the determination area is saturated. The determination area manager 110 may determine that the determination area is saturated when the number of saturated pixels is greater than the saturation threshold number.

In an embodiment of the present disclosure, the determination area manager 110 may determine at least one of the saturation reference value and the saturation threshold number based on the size of each determination area. For example, the determination area manager 110 may determine the saturation reference value or the saturation threshold number in proportion to the size of the determination area.

The defective pixel manager 120 may set reference pixels, among pixels included in the determination area, based on whether the determination area is saturated. Reference numeral 250 of FIG. 2 may represent white pixels included in the determination area by shaded portions, and reference numeral 260 of FIG. 2 may represent green pixels included in the determination area by shaded portions.

In an embodiment of the present disclosure, in response to the case in which the determination area is not in a saturated state, the defective pixel manager 120 may set white pixels included in the determination area as reference pixels. In an embodiment of the present disclosure, in response to the case in which the determination area is in a saturated state, the defective pixel manager 120 may set green pixels included in the determination area as the reference pixels.

Based on whether the determination area is saturated, the number of reference pixels included in the determination area may vary. The accuracy of defect determination may vary based on the number of reference pixels. The accuracy of defect determination may increase as the number of reference pixels increases.

The defective pixel manager 120 may calculate a reference value based on the first pixel values of the set reference pixels. The defective pixel manager 120 may calculate a dynamic range based on the difference between a maximum value and a minimum value, among the first pixel values. The defective pixel manager 120 may calculate the mean absolute deviation of the first pixel values. The defective pixel manager 120 may calculate the reference value based on the dynamic range and the mean absolute deviation of the first pixel values. In an embodiment of the present disclosure, the reference value may be the sum of a first value determined based on multiplying the dynamic range of the first pixel values with an experimentally determined first positive number and a second value determined based on multiplying the mean absolute deviation of the first pixel values with an experimentally determined second positive number.

Reference numeral 270 of FIG. 2 may represent blue pixels included in the determination area by shaded portions. In response to the case in which the candidate defective pixel is B54, pixels having the same color as the candidate defective pixel may be set as the determination pixels.

The defective pixel manager 120 may determine whether the candidate defective pixel has a defect based on the second pixel values of the determination pixels having the same color as the candidate defective pixel, among the pixels included in the determination area, and the reference value. The defective pixel manager 120 may determine whether the candidate defective pixel has a defect based on a defect threshold number and the number of homogenous pixels for which the difference between the pixel value of the candidate defective pixel, among the determination pixels, and the second pixel values is greater than the reference value.

The defective pixel manager 120 may determine the defect threshold number based on the size of each determination area. For example, the defective pixel manager 120 may set the defect threshold number in proportion to the size of each determination area. In the embodiment of the present disclosure, the defect threshold number may be 1 or more.

In an embodiment of the present disclosure, the color of the reference pixels and the color of the candidate defective pixel may be different from each other. For example, the color of the reference pixels may be green or white based on whether the determination area is saturated, but the color of the candidate defective pixel may be blue, red, green, or white. The defective pixel manager 120 may correct the reference value based on the ratio of the first pixel values to the second pixel values in response to the case in which the color of the reference pixels is different from the color of the candidate defective pixel. In detail, the defective pixel manager 120 may calculate a corrected reference value by multiplying a value, obtained by dividing the average of the first pixel values by the average of the second pixel values, by the calculated reference value.

The defective pixel manager 120 may determine, based on the corrected reference value, whether the candidate defective pixel has a defect. The defective pixel manager 120 may determine the candidate defective pixel to be a defective pixel or a normal pixel. The pixel value corrector 130 may correct the pixel value of the defective pixel in response to the case in which the candidate defective pixel is determined to be the defective pixel.

The pixel value corrector 130 may calculate slope values for preset directions based on the first pixel values. The pixel value corrector 130 may calculate temporary correction values corresponding to preset directions based on the second pixel values. The pixel value corrector 130 may correct the pixel value of the defective pixel based on the slope values and the temporary correction values.

In an embodiment of the present disclosure, the pixel value corrector 130 may calculate slope values for a horizontal direction, a vertical direction, a 45-degree direction, and a 135-degree direction, respectively. The pixel value corrector 130 may calculate the average pixel values of pixels respectively located in preset directions of the defective pixel, among the determination pixels, as temporary correction values. The pixel value corrector 130 may calculate the correction value for the defective pixel by obtaining a weighted sum of reciprocals of the slope values and the temporary correction values. The pixel value corrector 130 may output the correction value as the corrected pixel value of the defective pixel.

In an embodiment of the present disclosure, reference numeral 210 of FIG. 2 showing the case in which the candidate defective pixel is the blue pixel B54 is described below by way of example. The determination area manager 110 may generate a determination area having a size of 10×10. The determination area manager 110 may determine whether the determination area is saturated. Reference numeral 250 of FIG. 2 may represent white pixels that are used to determine whether the determination area is saturated. The determination area manager 110 may count the number of saturated pixels, the pixel values of which are greater than the saturation reference value, among W00, W02, W04, W06, W08, W11, W13, W15, W17, W19, W20, W22, W24, W26, W28, W31, W33, W35, W37, W39, W40, W42, W44, W46, W48, W51, W53, W55, W57, W59, W60, W62, W64, W66, W68, W71, W73, W75, W77, W79, W80, W82, W84, W86, W88, W91, W93, W95, W97, and W99. When the number of saturated pixels is greater than the saturation threshold number, the determination area manager 110 may determine that the determination area is in a saturated state.

In response to the case in which the determination area is in the saturated state, the determination area manager 110 may set green pixels included in the determination area as the reference pixels. Reference numeral 260 of FIG. 2 may represent green pixels G03, G07, G12, G16, G21, G25, G29, G30, G34, G38, G43, G47, G52, G56, G61, G65, G69, G70, G74, G78, G83, G87, G92, and G96, which are set as the reference pixels.

In an embodiment of the present disclosure, in response to the case in which the determination area is not in a saturated state, the determination area manager 110 may set white pixels included in the determination area as the reference pixels. Reference numeral 250 of FIG. 2 may represent white pixels W00, W02, W04, W06, W08, W11, W13, W15, W17, W19, W20, W22, W24, W26, W28, W31, W33, W35, W37, W39, W40, W42, W44, W46, W48, W51, W53, W55, W57, W59, W60, W62, W64, W66, W68, W71, W73, W75, W77, W79, W80, W82, W84, W86, W88, W91, W93, W95, W97, and W99, which are set as the reference pixels.

The defective pixel manager 120 may calculate the dynamic range and the mean absolute deviation of the reference pixels. The defective pixel manager 120 may calculate the reference value based on the calculated dynamic range and mean absolute deviation.

The defective pixel manager 120 may set blue pixels having the same color as the candidate defective pixel, among the pixels included in the determination area, as the determination pixels. Reference numeral 270 of FIG. 2 may represent blue pixels B01, B05, B09, B10, B14, B18, B41, B45, B49, B50, B54, B58, B81, B85, B89, B90, B94, and B98, which are set as the determination pixels. The defective pixel manager 120 may calculate a corrected reference value by multiplying the ratio of the pixel values of the reference pixels with the pixel values of the determination pixels by the calculated reference value.

The defective pixel manager 120 may count the number of determination pixels for which the difference between the pixel value of B54, among the determination pixels, and the pixel values of B01, B05, B09, B10, B14, B18, B41, B45, B49, B50, B58, B81, B85, B89, B90, B94, and B98 is greater than the corrected reference value. The defective pixel manager 120 may compare the count value with the defect threshold number. The defective pixel manager 120 may determine the candidate defective pixel to be the defective pixel in response to the case in which the count value is greater than the defect threshold number.

The pixel value corrector 130 may calculate slope values for preset directions based on the pixel values included in the determination area based on whether the determination area is saturated. The pixel value corrector 130 may calculate slope values for a horizontal direction, a vertical direction, a 45-degree direction, and a 135-degree direction by using the pixel values of the reference pixels.

The pixel value corrector 130 may calculate temporary correction values based on the pixel values of the pixels corresponding to the horizontal direction, the vertical direction, the 45-degree direction, and the 135-degree direction, among the determination pixels. For example, a temporary correction value corresponding to the horizontal direction may be the average pixel value of B50 and B58. For example, a temporary correction value corresponding to the vertical direction may be the average pixel value of B14 and B94. A temporary correction value corresponding to the 45-degree direction may be the average pixel value of B45 and B81. A temporary correction value corresponding to the 135-degree direction may be the average pixel value of B10 and B98.

The pixel value corrector 130 may sum up the temporary correction values corresponding to the horizontal direction, the vertical direction, the 45-degree direction, and the 135-degree direction by using the reciprocals of the slope values for the horizontal direction, the vertical direction, the 45-degree direction, and the 135-degree direction as weights. The pixel value corrector 130 may calculate the pixel value of B54 and may output the calculated pixel value.

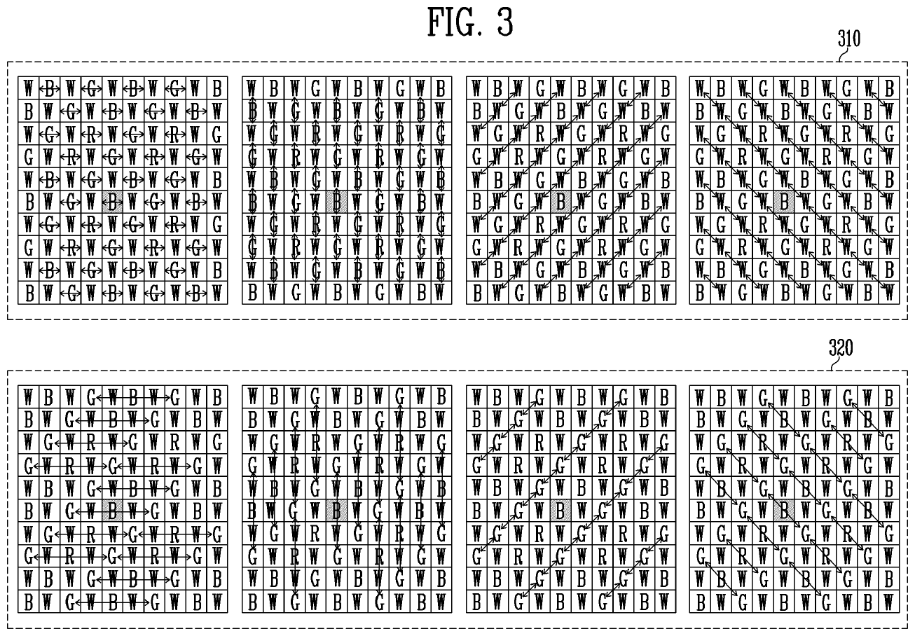

FIG. 3 is a diagram illustrating directions and slope values for correcting pixel values according to an embodiment of the present disclosure.

Referring to FIG. 3, the directions of slope values for correcting pixel values may be illustrated. In an embodiment of the present disclosure, preset directions may be a horizontal direction, a vertical direction, a 45-degree direction, and a 135-degree direction. FIG. 3 shows only an embodiment of the present disclosure, and various directions may be set to directions for correcting pixel values. For example, the directions of slope values may vary with the arrangement pattern of a color filter array included in an image sensor.

In FIG. 3, reference numeral 310 may represent slope values in response to the case whether a determination area is not in a saturated state. Reference numeral 320 may represent slope values in response to the case in which the determination area is in a saturated state. When the determination area is not in the saturated state, slope values may be calculated by using the pixel values of white pixels. When the determination area is in the saturated state, the slope values may be calculated by using the pixel values of green pixels regardless of the color of a candidate defective pixel.

Because a method of calculating slope values for preset directions based on the pixel values is well-known technology, detailed description thereof may be omitted in the present specification.

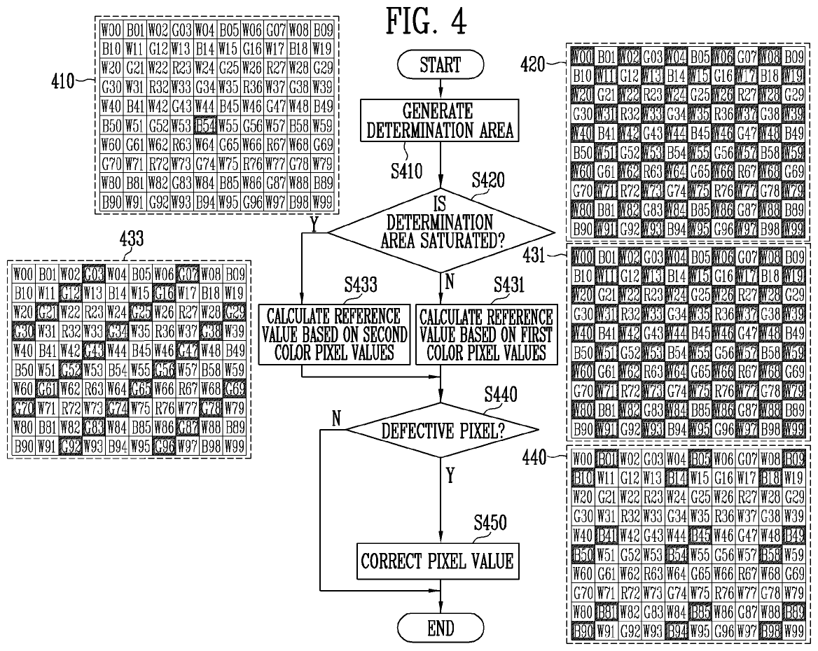

FIG. 4 is a flowchart illustrating an image processing method according to an embodiment of the present disclosure.

Referring to FIG. 4, an image processing device 100 may detect a defective pixel based on externally received pixel values and may correct the pixel value of the defective pixel. The image processing device 100 may improve the quality of a sensed image by outputting corrected pixel values. An image sensor, which senses an image, may include a color filter array including white pixels. FIG. 4 may be described, together with the components of FIG. 2.

At step S410, the determination area manager 110 may generate a determination area corresponding to a candidate defective pixel based on the externally received pixel values. Reference numeral 410 of FIG. 4 may show the determination area generated in response to the case in which a blue pixel B54 is a candidate defective pixel. Reference numeral 410 of FIG. 4 may correspond to reference numeral 210 of FIG. 2. The determination area manager 110 may determine the size of the determination area so that the number of determination pixels is greater than a preset threshold value.

At step S420, based on the pixel values of white pixels included in the determination area, the determination area manager 110 may determine whether the determination area is saturated. Reference number 420 of FIG. 4 may represent white pixels included in the determination area by shaded portions. Reference numeral 420 of FIG. 4 may correspond to reference numeral 250 of FIG. 2. The determination area manger 110 may determine that the determination area is in a saturated state in response to the case in which the number of saturated pixels, the pixel values of which are greater than a saturation reference value, among the white pixels, is greater than a saturation threshold number.

At step S431, the defective pixel manager 120 may set first color pixels included in the determination area as reference pixels in response to the case in which the determination area is not in a saturated state. The defective pixel manager 120 may calculate a reference value based on first color pixel values.

In an embodiment of the present disclosure, the first color pixels may be white pixels included in the determination area, and the first color pixel values may be first pixel values of the reference pixels. Reference numeral 431 of FIG. 4 may represent white pixels included in the determination area by shaded portions in response to the case in which the determination area is not in a saturated state.

The defective pixel manager 120 may calculate the reference value based on the first pixel values of the reference pixels. The defective pixel manager 120 may calculate the reference value based on a dynamic range, which is the difference between a maximum value and a minimum value, among the first pixel values, and the mean absolute deviation of the first pixel values. The defective pixel manager 120 may correct the reference value in response to the case in which the color of the reference pixels is different from the color of the candidate defective pixel. The corrected reference value may be a value based on multiplying a value, which is obtained by dividing the average pixel value of determination pixels having the same color as the candidate defective pixel, among the pixels included in the determination area by the average pixel value of the reference pixels, by the calculated reference value.

At step S433, the defective pixel manager 120 may set second color pixels included in the determination area as reference pixels in response to the case in which the determination area is in a saturated state. The defective pixel manager 120 may calculate a reference value based on second color pixel values.

In an embodiment of the present disclosure, the second color pixels may be green pixels included in the determination area, and the second color pixel values may be first pixel values of the reference pixels. Reference numeral 433 of FIG. 4 may represent green pixels included in the determination area by shaded portions in response to the case in which the determination area is in a saturated state. A method in which the defective pixel manager 120 calculates the reference value may correspond to the method in which the defective pixel manager calculates the reference value based on the first pixel values of the reference pixels at step S431.

At step S440, the defective pixel manager 120 may determine whether the candidate defective pixel has a defect based on the second pixel values of the determination pixels and the reference value. In an embodiment of the present disclosure, the determination pixels may be pixels having the same color as the candidate defective pixel included in the determination area. Reference numeral 440 of FIG. 4 may represent determination pixels corresponding to the blue pixel B54, which is the candidate defective pixel, by shaded portions. Reference numeral 440 of FIG. 4 may correspond to reference numeral 270 of FIG. 2.

The defective pixel manager 120 may determine the corresponding candidate defective pixel to be a defective pixel in response to the case in which the number of homogeneous pixels, for which the difference between the pixel value of the candidate defective pixel, among the determination pixels, and the second pixel values is greater than the reference value, is greater than the defect threshold number. On the other hand, when the number of homogeneous pixels for which the difference between the pixel value of the candidate defective pixel and the second pixel values is greater than the reference value is less than or equal to the defect threshold number, the defective pixel manager 120 may determine the candidate defective pixel to be a normal pixel. The defective pixel manager 120 may output the pixel value of the candidate defective pixel, which is determined to be a normal pixel, without any change.

At step S450, in response to the case in which the candidate defective pixel is determined to be a defective pixel, the pixel value corrector 130 may correct the pixel value of the defective pixel based on slope values, calculated for preset directions, and temporary correction values. The pixel value corrector 130 may output the corrected pixel value as the pixel value of the defective pixel.

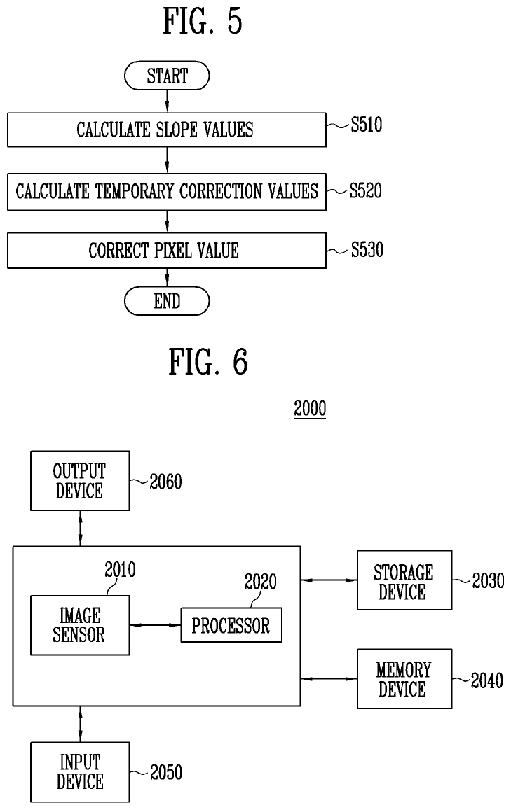

FIG. 5 is a flowchart illustrating a method of correcting a defective pixel according to an embodiment of the present disclosure.

Referring to FIG. 5, the pixel value corrector 130 may correct the pixel value of the defective pixel based on the slope values for a horizontal direction, a vertical direction, a 45-degree direction, and a 135-degree direction. Based on whether the determination area is saturated, pixels to be used to calculate the slope values may vary. FIG. 5 may be described, together with the components of FIG. 2.

At step S510, the pixel value corrector 130 may calculate slope values for preset directions based on first pixel values. The pixel value corrector 130 may calculate the slope values based on the pixel values of green pixels or white pixels included in the determination area based on whether determination pixels are saturated.

At step S520, the pixel value corrector 130 may calculate temporary correction values corresponding to preset directions based on second pixel values. Because the determination pixels are irrelevant to whether the determination area is saturated, the pixel value corrector 130 may calculate the temporary correction values based on the pixel values of the pixels determined based on the color of the defective pixel. In an embodiment of the present disclosure, the pixel value corrector 130 may calculate the temporary correction values corresponding to four directions.

At step S530, the pixel value corrector 130 may correct the pixel value of the defective pixel based on the slope values and the temporary correction values corresponding to the preset directions. The pixel value corrector 130 may calculate the corrected pixel value by obtaining a weighted sum of reciprocals of the slope values and the temporary correction values.

In an embodiment of the present disclosure, the accuracy of the corrected pixel value may be higher as the size of the determination area increases. The complexity of detection of a defective pixel and calculation of a correction value may be increased as the size of the determination area increases. The accuracy of a corrected pixel value and the complexity of detection of a defective pixel and calculation of a correction value may be in a trade-off relationship.

FIG. 6 is a block diagram illustrating an electronic device including an image processing device according to an embodiment of the present disclosure.

Referring to FIG. 6, an electronic device 2000 may include an image sensor 2010, a processor 2020, a storage device 2030, a memory device 2040, an input device 2050, and an output device 2060. Although not illustrated in FIG. 6, the electronic device 2000 may further include ports which are capable of communicating with a video card, a sound card, a memory card, or a universal serial bus (USB) device, or communicate with other electronic devices.

The image sensor 2010 may generate image data corresponding to incident light. In an embodiment of the present disclosure, the image sensor 2010 may include white pixels. The white pixels may increase the resolution of the image sensor 2010 in a low-illuminance environment. The image sensor 2010 may include pixels corresponding to various colors such as green, red, and blue, as well as the white pixels.

The image data may be transferred to and processed by the processor 2020. The output device 2060 may display the image data. The storage device 2030 may store the image data. The processor 2020 may control the operations of the image sensor 2010, the output device 2060, and the storage device 2030.

The processor 2020 may be an image processing device that performs an operation of processing the image data received from the image sensor 2010 and outputs the processed image data. Here, processing may include electronic image stabilization (EIS), interpolation, tonal (hue) correction, image quality correction, size adjustment, etc.

The processor 2020 may be implemented as a chip independent of the image sensor 2010. For example, the processor 2020 may be implemented as a multi-chip package. In an embodiment of the present disclosure, the processor 2020 and the image sensor 2010 may be integrated into a single chip so that the processor 2020 is included as a part of the image sensor 2010.

The processor 2020 may execute and control the operation of the electronic device 2000. In accordance with an embodiment of the present disclosure, the processor 2020 may be a microprocessor, a central processing unit (CPU), or an application processor (AP). The processor 2020 may be coupled to the storage device 2030, the memory device 2040, the input device 2050, and the output device 2060 through an address bus, a control bus, and a data bus, and may then communicate with the devices.

In an embodiment of the present disclosure, the processor 2020 may detect a defective pixel based on pixel data received from the image sensor 2010 and may correct the pixel value of the defective pixel. The determination area manager 2020 may generate a determination area corresponding to a candidate defective pixel. The determination area manager 2020 may determine whether the determination area is saturated based on the pixel values of white pixels included in the determination area. The processor 2020 may calculate a reference value based on the pixel values of reference pixels that are set based on whether the determination area is saturated. The processor 2020 may determine the candidate defective pixel to be a defective pixel or a normal pixel based on the pixel values of determination pixels having the same color as the candidate defective pixel and the reference value. The processor 2020 may calculate a correction value based on slope values, which are calculated for preset directions, and temporary correction values, which are calculated based on the pixel values of the determination pixels, in response to the case in which the candidate defective pixel is determined to be a defective pixel. The processor 2020 may output the calculated correction value as the pixel value of the defective pixel.

The storage device 2030 may include all types of nonvolatile memory devices including a flash memory device, a solid state drive (SSD), a hard disk drive (HDD), and a CD-ROM.

The memory device 2040 may store data required for the operation of the electronic device 2000. For example, the memory device 2040 may include a volatile memory device such as a dynamic random access memory (DRAM) or a static random access memory (SRAM), and a nonvolatile memory device, such as an erasable programmable read-only memory (EPROM), an electrically erasable programmable read-only memory (EEPROM), or a flash memory device. The processor 2020 may control the image sensor 2010 and the output device 2060 by executing an instruction set stored in the memory device 2040.

The input device 2050 may include an input means, such as a keyboard, a keypad, or a mouse, and the output device 2060 may include an output means, such as a printer device or a display.

The image sensor 2010 may be implemented as various types of packages. For example, at least some components of the image sensor 2010 may be implemented by using any of packages, such as package on package (PoP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline integrated circuit (SOIC), shrink small outline package (SSOP), thin small outline package (TSOP), system in package (SIP), multi-chip package (MCP), wafer-level fabricated package (WFP), and wafer-level processed stack package (WSP).

Meanwhile, the electronic device 2000 may be construed as any of all computing systems by using the image sensor 2010. The electronic device 2000 may be implemented in the form of a packaged module, a part or the like. For example, the electronic device 2000 may be implemented as a digital camera, a mobile device, a smartphone, a personal computer (PC), a tablet PC, a notebook computer, a personal digital assistant (PDA), an enterprise digital assistant (EDA), a portable multimedia player (PMP), a wearable device, a black box, a robot, an autonomous vehicle, or the like.

According to the present disclosure, there may be provided an image processing method, which detect a defective pixel in response to saturation of white pixels and correct the pixel value of the defective pixel.

It should be noted that the scope of the present disclosure is defined by the accompanying claims, rather than by the foregoing detailed descriptions, and all changes or modifications derived from the meaning and scope of the claims and equivalents thereof are included in the scope of the present disclosure.

What is claimed is:

1. An image processing device, comprising:
a determination area manager configured to generate a determination area corresponding to a candidate defective pixel based on externally received pixel values and configured to determine whether the determination area is saturated based on pixel values of white pixels included in the determination area; and
a defective pixel manager configured to calculate a reference value based on first pixel values of reference pixels that are set based on whether the white pixels are saturated and to determine whether a candidate defective pixel has a defect based on both the reference value and second pixel values of determination pixels having a color identical to that of the candidate defective pixel, among pixels included in the determination area.

2. The image processing device according to claim 1, wherein the determination area manager determines a size of the determination area based on a color of the candidate defective pixel.

3. The image processing device according to claim 1, wherein the determination area manager determines a size of the determination area based on the number of the determination pixels.

4. The image processing device according to claim 1, wherein the determination area manager counts the number of the saturated white pixels, pixel values of which are greater than a saturation reference value, and determines whether the determination area is saturated based on the number of the saturated white pixels and a saturation threshold number.

5. The image processing device according to claim 4, wherein the determination area manager determines at least one of the saturation reference value or the saturation threshold number based on a size of the determination area.

6. The image processing device according to claim 1, wherein the defective pixel manager calculates the reference value based on both a mean absolute deviation of the first pixel values and a dynamic range that is a difference between a maximum value and a minimum value, among the first pixel values.

7. The image processing device according to claim 1, wherein the defective pixel manager corrects the reference value based on a ratio of the first pixel values to the second pixel values in response to a case in which a color of the reference pixels is different from a color of the candidate defective pixel.

8. The image processing device according to claim 1, wherein the defective pixel manager determines whether the candidate defective pixel has a defect based on both a defect threshold number and a number of homogenous pixels for which a difference between the second pixel values and a pixel value of the candidate defective pixel, among the determination pixels, is greater than the reference value.

9. The image processing device according to claim 8, wherein the defective pixel manager determines the defect threshold number based on a size of the determination area.

10. The image processing device according to claim 1, wherein the defective pixel manager sets green pixels included in the determination area as the reference pixels in response to a case in which the determination area is in a saturated state.

11. The image processing device according to claim 1, wherein the defective pixel manager sets white pixels included in the determination area as the reference pixels in response to a case in which the determination area is not in a saturated state.

12. The image processing device according to claim 1, wherein the defective pixel manager comprises:
a pixel value corrector, in response to a case in which the candidate defective pixel is determined to be a defective pixel, configured to:
calculate slope values for preset directions based on the first pixel values;
calculate temporary correction values corresponding to the preset directions based on the second pixel values; and
correct a pixel value of a defective pixel based on the slope values and the temporary correction values.

13. The image processing device according to claim 12, wherein the pixel value corrector:
calculates a correction value for the defective pixel by obtaining a weighted sum of reciprocals of the slope values and the temporary correction values, and
outputs the correction value.

14. The image processing device according to claim 12, wherein the pixel value corrector calculates the slope values for a horizontal direction, a vertical direction, a 45-degree direction, and a 135-degree direction.

15. The image processing device according to claim 12, wherein the pixel value corrector calculates average pixel values of pixels respectively located in the preset directions of the defective pixel, among the determination pixels, as the temporary correction values.

16. An image processing method, comprising:
generating a determination area corresponding to a candidate defective pixel based on externally received pixel values;
determining whether the determination area is saturated based on pixel values of white pixels included in the determination area;
calculating a reference value based on first pixel values of reference pixels that are set based on whether the white pixels are saturated; and
determining whether the candidate defective pixel has a defect based on both the reference value and second pixel values of determination pixels having a color identical to that of the candidate defective pixel, among pixels included in the determination area.

17. The image processing method according to claim 16, wherein the generating of the determination area comprises:
determining a size of the determination area such that the number of the determination pixels is greater than a preset threshold value.

18. The image processing method according to claim 16, wherein the determining of whether the determination area is saturated comprises:
counting the number of the saturated white pixels, pixel values of which are greater than a saturation reference value; and
determining whether the determination area is saturated based on the number of the saturated white pixels and a saturation threshold number.

19. The image processing method according to claim 16, wherein the calculating of the reference value comprises:
calculating the reference value based on a dynamic range that is a difference between a mean absolute deviation of the first pixel values and a maximum value and a minimum value, among the first pixel values; and
correcting the reference value based on a ratio of the first pixel values to the second pixel values in response to a case in which a color of the reference pixels is different from a color of the candidate defective pixel.

20. The image processing method according to claim 16, wherein the determining of whether the candidate defective pixel has a defect comprises:
determining whether the candidate defective pixel has a defect based on a defect threshold number and a number of homogenous pixels for which a difference between the second pixel values and a pixel value of the candidate defective pixel, among the determination pixels, is greater than the reference value.

21. The image processing method according to claim 16, wherein the calculating of the reference value comprises:
setting green pixels included in the determination area as the reference pixels in response to a case in which the determination area is in a saturated state.

22. The image processing method according to claim 16, wherein the calculating of the reference value comprises:
setting white pixels included in the determination area as the reference pixels in response to a case in which the determination area is not in a saturated state.

23. The image processing method according to claim 16, further comprising:
in response to a case in which the candidate defective pixel is determined to be a defective pixel:
calculating slope values for preset directions based on the first pixel values;
calculating temporary correction values corresponding to the preset directions based on the second pixel values; and
correcting a pixel value of the defective pixel based on the slope values and the temporary correction values.

24. An image processing system, comprising:
an image sensor including white pixels and non-white color pixels; and
an image processing device configured to detect defective pixels included in the image sensor based on pixel values received from the image sensor and configured to correct pixel values of the defective pixels,
wherein the image processing device comprises:
a determination area manager configured to generate a determination area corresponding to a candidate defective pixel based on the pixel values and configured to determine whether the determination area is saturated based on pixel values of white pixels included in the determination area;
a defective pixel manager configured to:
set white pixels included in the determination area or pixels of another color, among the non-white color pixels, next largest to a number of white pixels included in the determination area, as reference pixels based on whether the white pixels are saturated;
to calculate a reference value based on first pixel values of the reference pixels; and
to determine the candidate defective pixel to be a defective pixel or a normal pixel based on both the reference value and second pixel values of determination pixels having a color identical to that of the candidate defective pixel, among the pixels included in the determination area; and
a pixel value corrector, in response to a case in which the candidate defective pixel is determined to be a defective pixel, configured to:
calculate slope values for preset directions based on the first pixel values;
calculate temporary correction values corresponding to the preset directions based on the second pixel values;
calculate a correction value by obtaining a weighted sum of reciprocals of the slope values and the temporary correction values; and
output the correction value as a pixel value of the defective pixel.
